(19) United States
(12) Patent Application Publication
(10) Pub. No.: US 2016/0165339 A1
(43) Pub. Date: Jun. 9, 2016

(54) MICROPHONE ARRAY AND AUDIO SOURCE TRACKING SYSTEM

(71) Applicant: STAGES PCS, LLC, Princeton, NJ (US)

(72) Inventor: Benjamin D. Benattar, Cranbury, NJ (US)

(73) Assignee: STAGES PCS, LLC, Ewing, NJ (US)

(21) Appl. No.: 14/827,317

(22) Filed: Aug. 15, 2015

Related U.S. Application Data
(63) Continuation-in-part of application No. 14/561,972, filed on Dec. 5, 2014.

(51) Int. Cl. H04R 1/40; H04R 3/00

(52) U.S. Cl. CPC H04R 1/406; H04R 3/005

(57) ABSTRACT

A microphone array of three or more microphones may be mounted on a housing or substrate configured to be mounted on or worn by a person. The microphone array may be positioned so that the far field sensing range of the microphone array is unobstructed by the housing or wearer. An accelerometer may be provided and mounted in a location which is fixed with respect to the microphones of the microphone array. The microphone array may be utilized with a beam-forming system in order to determine location of an audio source and a beam-steering system in order to isolate audio emanating from the direction of the audio source. The beam-forming system may be suitable for tracking the movement of one or more audio sources in order to inform the beam-steering system of the direction or location to be isolated. Because the microphone array will move with a user, an accelerometer may be provided to reduce the computational resources required for tracking and isolation by allowing compensation for change in position and orientation of the user/microphone array.

### CROSS REFERENCE TO RELATED APPLICATIONS

This application is a continuation-in-part of co-pending U.S. patent application Ser. No. 14/561,972 filed Dec. 5, 2014, U.S. Pat. No. ______, and priority is claimed therefrom, the disclosure of which is hereby incorporated herein by reference. This patent application contains subject matter related to U.S. patent application Ser. Nos. ______ (Attorney Docket Number 111003); ______ (Attorney Docket Number 111004); ______ (Attorney Docket Number 111008); ______ (Attorney Docket Number 111009); and ______ (Attorney Docket Number 111010).

### BACKGROUND OF THE INVENTION

1. Field of the Invention

The invention relates to microphone arrays and particularly to body-mounted microphone arrays. In addition, the invention relates to audio source tracking systems.

2. Description of the Related Technology

A microphone is an acoustic-to-electric transducer or sensor that converts sound into an electrical signal. Personal audio is typically delivered to a user by headphones. Headphones are a pair of small speakers that are designed to be held in place close to a user's ears. They may be electroacoustic transducers which convert an electrical signal to a corresponding sound in the user's ear. Headphones are designed to allow a single user to listen to an audio source privately, in contrast to a loudspeaker which emits sound into the open air, allowing anyone nearby to listen. Earbuds or earphones are in-ear versions of headphones.

A sensitive transducer element of a microphone is called its element or capsule. Except in thermophone based microphones, sound is first converted to mechanical motion by means of a diaphragm, the motion of which is then converted to an electrical signal. A complete microphone also includes a housing, some means of bringing the signal from the element to other equipment, and often an electronic circuit to adapt the output of the capsule to the equipment being driven. A wireless microphone contains a radio transmitter.

The condenser microphone, is also called a capacitor microphone or electrostatic microphone. Here, the diaphragm acts as one plate of a capacitor, and the vibrations produce changes in the distance between the plates.

A fiber optic microphone converts acoustic waves into electrical signals by sensing changes in light intensity, instead of sensing changes in capacitance or magnetic fields as with conventional microphones. During operation, light from a laser source travels through an optical fiber to illuminate the surface of a reflective diaphragm. Sound vibrations of the diaphragm modulate the intensity of light reflecting off the diaphragm in a specific direction. The modulated light is then transmitted over a second optical fiber to a photo detector, which transforms the intensity-modulated light into analog or digital audio for transmission or recording. Fiber optic microphones possess high dynamic and frequency range, similar to the best high fidelity conventional microphones. Fiber optic microphones do not react to or influence any electrical, magnetic, electrostatic or radioactive fields (this is called EMI/RFI immunity). The fiber optic microphone design is therefore ideal for use in areas where conventional microphones are ineffective or dangerous, such as inside industrial turbines or in magnetic resonance imaging (MRI) equipment environments.

Fiber optic microphones are robust, resistant to environmental changes in heat and moisture, and can be produced for any directionality or impedance matching. The distance between the microphone's light source and its photo detector may be up to several kilometers without need for any preamplifier or other electrical device, making fiber optic microphones suitable for industrial and surveillance acoustic monitoring. Fiber optic microphones are suitable for use application areas such as for infrasound monitoring and noise-canceling.

U.S. Pat. No. 6,462,808 B2, the disclosure of which is incorporated by reference herein shows a small optical microphone/sensor for measuring distances to, and/or physical properties of, a reflective surface

The MEMS (MicroElectrical-Mechanical System) microphone is also called a microphone chip or silicon microphone. A pressure-sensitive diaphragm is etched directly into a silicon wafer by MEMS processing techniques, and is usually accompanied with integrated preamplifier. Most MEMS microphones are variants of the condenser microphone design. Digital MEMS microphones have built in analog-to-digital converter (ADC) circuits on the same CMOS chip making the chip a digital microphone and so more readily integrated with modern digital products. Major manufacturers producing MEMS silicon microphones are Wolfson Microelectronics (WM7xxx), Analog Devices, Akustica (AKU200x), Infineon (SMM310 product), Knowles Electronics, Memstech (MSMx), NXP Semiconductors, Sonion MEMS, Vesper, AAC Acoustic Technologies, and Omron.

A microphone's directionality or polar pattern indicates how sensitive it is to sounds arriving at different angles about its central axis. The polar pattern represents the locus of points that produce the same signal level output in the microphone if a given sound pressure level (SPL) is generated from that point. How the physical body of the microphone is oriented relative to the diagrams depends on the microphone design. Large-membrane microphones are often known as “side fire” or “side address” on the basis of the sideward orientation of their directionality. Small diaphragm microphones are commonly known as “end fire” or “top/end address” on the basis of the orientation of their directionality.

Some microphone designs combine several principles in creating the desired polar pattern. This ranges from shielding (meaning diffraction/dissipation/absorption) by the housing itself to electronically combining dual membranes.

An omnidirectional (or nondirectional) microphone's response is generally considered to be a perfect sphere in three dimensions. In the real world, this is not the case. As with directional microphones, the polar pattern for an “omnidirectional” microphone is a function of frequency. The body of the microphone is not infinitely small and, as a consequence, it tends to get in its own way with respect to sounds arriving from the rear, causing a slight flattening of the polar response. This flattening increases as the diameter of the microphone (assuming it's cylindrical) reaches the wavelength of the frequency in question.

A unidirectional microphone is sensitive to sounds from only one direction.

A noise-canceling microphone is a highly directional design intended for noisy environments. One such use is in aircraft cockpits where they are normally installed as boom microphones on headsets. Another use is in live event support on loud concert stages for vocalists involved with live performances. Many noise-canceling microphones combine signals received from two diaphragms that are in opposite electrical polarity or are processed electronically. In dual diaphragm designs, the main diaphragm is mounted closest to the intended source and the second is positioned farther away from the source so that it can pick up environmental sounds to be subtracted from the main diaphragm's signal. After the two signals have been combined, sounds other than the intended source are greatly reduced, substantially increasing intelligibility. Other noise-canceling designs use one diaphragm that is affected by ports open to the sides and rear of the microphone.

Sensitivity indicates how well the microphone converts acoustic pressure to output voltage. A high sensitivity microphone creates more voltage and so needs less amplification at the mixer or recording device. This is a practical concern but is not directly an indication of the microphone's quality, and in fact the term sensitivity is something of a misnomer, “transduction gain” being perhaps more meaningful, (or just “output level”) because true sensitivity is generally set by the noise floor, and too much “sensitivity” in terms of output level compromises the clipping level.

A microphone array is any number of microphones operating in tandem. Microphone arrays may be used in systems for extracting voice input from ambient noise (notably telephones, speech recognition systems, hearing aids), surround sound and related technologies, binaural recording, locating objects by sound: acoustic source localization, e.g., military use to locate the source(s) of artillery fire, aircraft location and tracking.

Typically, an array is made up of omnidirectional microphones, directional microphones, or a mix of omnidirectional and directional microphones distributed about the perimeter of a space, linked to a computer that records and interprets the results into a coherent form. Arrays may also be formed using numbers of very closely spaced microphones. Given a fixed physical relationship in space between the different individual microphone transducer array elements, simultaneous DSP (digital signal processor) processing of the signals from each of the individual microphone array elements can create one or more “virtual” microphones.

Beamforming or spatial filtering is a signal processing technique used in sensor arrays for directional signal transmission or reception. This is achieved by combining elements in a phased array in such a way that signals at particular angles experience constructive interference while others experience destructive interference. A phased array is an array of antennas, microphones or other sensors in which the relative phases of respective signals are set in such a way that the effective radiation pattern is reinforced in a desired direction and suppressed in undesired directions. The phase relationship may be adjusted for beam steering. Beamforming can be used at both the transmitting and receiving ends in order to achieve spatial selectivity. The improvement compared with omnidirectional reception/transmission is known as the receive/transmit gain (or loss).

Adaptive beamforming is used to detect and estimate a signal-of-interest at the output of a sensor array by means of optimal (e.g., least-squares) spatial filtering and interference rejection.

To change the directionality of the array when transmitting, a beamformer controls the phase and relative amplitude of the signal at each transmitter, in order to create a pattern of constructive and destructive interference in the wavefront. When receiving, information from different sensors is combined in a way where the expected pattern of radiation is preferentially observed.

With narrow-band systems the time delay is equivalent to a “phase shift”, so in the case of a sensor array, each sensor output is shifted a slightly different amount. This is called a phased array. A narrow band system, typical of radars or small microphone arrays, is one where the bandwidth is only a small fraction of the center frequency. With wide band systems this approximation no longer holds, which is typical in sonars.

In the receive beamformer the signal from each sensor may be amplified by a different “weight.” Different weighting patterns (e.g., Dolph-Chebyshev) can be used to achieve the desired sensitivity patterns. A main lobe is produced together with nulls and sidelobes. As well as controlling the main lobe width (the beam) and the sidelobe levels, the position of a null can be controlled. This is useful to ignore noise or jammers in one particular direction, while listening for events in other directions. A similar result can be obtained on transmission.

Beamforming techniques can be broadly divided into two categories:
a. conventional (fixed or switched beam) beamformers
b. adaptive beamformers or phased array
   i. desired signal maximization mode
   ii. interference signal minimization or cancellation mode

Conventional beamformers use a fixed set of weightings and time-delays (or phasings) to combine the signals from the sensors in the array, primarily using only information about the location of the sensors in space and the wave directions of interest. In contrast, adaptive beamforming techniques generally combine this information with properties of the signals actually received by the array, typically to improve rejection of unwanted signals from other directions. This process may be carried out in either the time or the frequency domain.

As the name indicates, an adaptive beamformer is able to automatically adapt its response to different situations. Some criterion has to be set up to allow the adaption to proceed such as minimizing the total noise output. Because of the variation of noise with frequency, in wide band systems it may be desirable to carry out the process in the frequency domain.

Beamforming can be computationally intensive.

Beamforming can be used to try to extract sound sources in a room, such as multiple speakers in the cocktail party problem. This requires the locations of the speakers to be known in advance, for example by using the time of arrival from the sources to mics in the array, and inferring the locations from the distances.

A Primer on Digital Beamforming by Toby Haynes, Mar. 26, 1998 http://www.spectrumsignal.com/publications/beamform_primer.pdf describes beam forming technology.

According to U.S. Pat. No. 5,581,620, the disclosure of which is incorporated by reference herein, many communication systems, such as radar systems, sonar systems and microphone arrays, use beamforming to enhance the reception of signals. In contrast to conventional communication systems that do not discriminate between signals based on the position of the signal source, beamforming systems are characterized by the capability of enhancing the reception of signals generated from sources at specific locations relative to the system.

Generally, beamforming systems include an array of spatially distributed sensor elements, such as antennas, sonar phones or microphones, and a data processing system for combining signals detected by the array. The data processor combines the signals to enhance the reception of signals from sources located at select locations relative to the sensor elements. Essentially, the data processor “aims” the sensor array in the direction of the signal source. For example, a linear microphone array uses two or more microphones to pick up the voice of a talker. Because one microphone is closer to the talker than the other microphone, there is a slight time delay between the two microphones. The data processor adds a time delay to the nearest microphone to coordinate these two microphones. By compensating for this time delay, the beamforming system enhances the reception of signals from the direction of the talker, and essentially aims the microphones at the talker.

A beamforming apparatus may connect to an array of sensors, e.g. microphones that can detect signals generated from a signal source, such as the voice of a talker. The sensors can be spatially distributed in a linear, a two-dimensional array or a three-dimensional array, with a uniform or non-uniform spacing between sensors. A linear array is useful for an application where the sensor array is mounted on a wall or a podium talker is then free to move about a half-plane with an edge defined by the location of the array. Each sensor detects the voice audio signals of the talker and generates electrical response signals that represent these audio signals. An adaptive beamforming apparatus provides a signal processor that can dynamically determine the relative time delay between each of the audio signals detected by the sensors. Further, a signal processor may include a phase alignment element that uses the time delays to align the frequency components of the audio signals. The signal processor has a summation element that adds together the aligned audio signals to increase the quality of the desired audio source while simultaneously attenuating sources having different delays relative to the sensor array. Because the relative time delays for a signal relate to the position of the signal source relative to the sensor array, the beamforming apparatus provides, in one aspect, a system that “aims” the sensor array at the talker to enhance the reception of signals generated at the location of the talker and to diminish the energy of signals generated at locations different from that of the desired talker's location. The practical application of a linear array is limited to situations which are either in a half plane or where knowledge of the direction to the source in not critical. The addition of a third sensor that is not co-linear with the first two sensors is sufficient to define a planar direction, also known as azimuth. Three sensors do not provide sufficient information to determine elevation of a signal source. At least a fourth sensor, not co-planar with the first three sensors is required to obtain sufficient information to determine a location in a three dimensional space.

Although these systems work well if the position of the signal source is precisely known, the effectiveness of these systems drops off dramatically and computational resources required increases dramatically with slight errors in the estimated a priori information. For instance, in some systems with source-location schemes, it has been shown that the data processor must know the location of the source within a few centimeters to enhance the reception of signals. Therefore, these systems require precise knowledge of the position of the source, and precise knowledge of the position of the sensors. As a consequence, these systems require both that the sensor elements in the array have a known and static spatial distribution and that the signal source remains stationary relative to the sensor array. Furthermore, these beamforming systems require a first step for determining the talker position and a second step for aiming the sensor array based on the expected position of the talker.

A change in the position and orientation of the sensor can result in the aforementioned dramatic effects even if the talker is not moving due to the change in relative position and orientation due to movement of the arrays. Knowledge of any change in the location and orientation of the array can compensate for the increase in computational resources and decrease in effectiveness of the location determination and sound isolation. An accelerometer is a device that measures acceleration of an object rigidly inked to the accelerometer. The acceleration and timing can be used to determine a change in location and orientation of an object linked to the accelerometer.

### SUMMARY OF THE INVENTION

It is an object of the invention to provide a location sensing microphone array.

The invention may, among other things, facilitate determination of the location of an audio source with a 360-degree range.

It is an object of the invention to have a microphone array with a 360-degree range.

It is an object of the invention to have a body-mounted microphone array.

According to an embodiment of the invention the microphone array has three or more spatially-separated microphone elements.

A microphone array may have a base configured to be worn by a user; and three or more microphones mounted on the base; wherein the microphones are mounted in a configuration with a first microphone mounted in a position that is not co-linear with a second microphone and a third microphone.

The microphones may be mounted on the base in a configuration where, for every angle of azimuth referenced from said microphone array from 0 degrees to 360 degrees, there are at least two microphones in said array which include the angle of azimuth within their field of sensitivity and are unobstructed by said base and user.

The base may be a pair of headphones.

The microphones may be mounted on a headband of the headphones or substrate attached to a headband of the headphones or substrate attached to the headphones.

The microphone array may have 8 microphones in a generally coplanar configuration.

The substrate may be a wearable collar.

The microphones may be mounted on a hat.

The microphone array of the audio source location tracking and isolation system may be mounted on a base configured to be worn on a user.

The beam-forming and beam-sensing functions may be implemented in using one or more processors, advantageously digital signal processors.

The article of manufacture of the invention may include software for a microphone array and source tracking system, comprising instruction stored in non-volatile memory.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows a pair of headphones with an embodiment of a microphone array according to the invention.

FIG. 2 shows a top view of a pair of headphones with a microphone array according to an embodiment of the invention.

FIG. 3 shows a collar-mounted microphone array.

FIG. 4 illustrates a collar-mounted microphone array positioned on a user.

FIG. 5 illustrates a hat-mounted microphone array according an embodiment of the invention.

FIG. 6 shows a further embodiment of a microphone array according to an embodiment of the invention.

FIG. 7 shows a top view of a mounting substrate.

FIG. 8 shows an audio source location and isolation system.

### DETAILED DESCRIPTION OF PREFERRED EMBODIMENTS

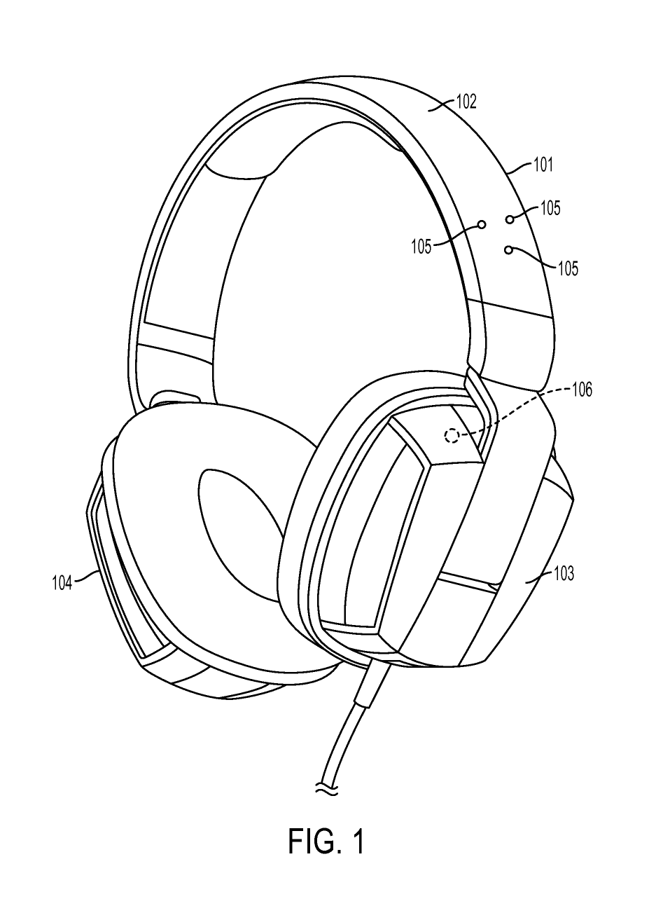

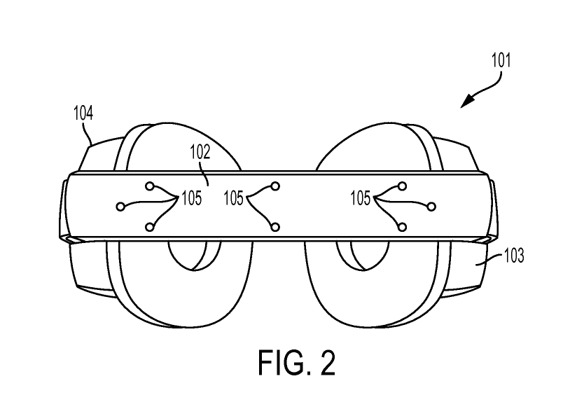

FIG. 1 and FIG. 2 show a pair of headphones with an embodiment of a microphone array according to the invention. FIG. 2 shows a top view of a pair of headphones with a microphone array according to an embodiment of the invention.

The headphones 101 include a headband 102. The headband 102 forms an arc which when in use sits over the user's head. The headphones 101 also include ear speakers 103 and 104 connected to the headband 102. The ear speakers 103 and 104 are colloquially referred to as “cans.” A plurality of microphones 105 are mounted on the headband 102. There should be three or more microphones according to an advantageous embodiment where at least one of the microphones is not positioned co-linearly with the other two microphones.

The microphones in the microphone array are mounted such that they are not obstructed by the structure of the headphones or the user's body. Advantageously the microphone array is configured to have a 360-degree field. An obstruction exists when a point in the space around the array is not within the field of sensitivity of at least two microphones in the array. An accelerometer 106 may be mounted in an ear speaker housing 103.

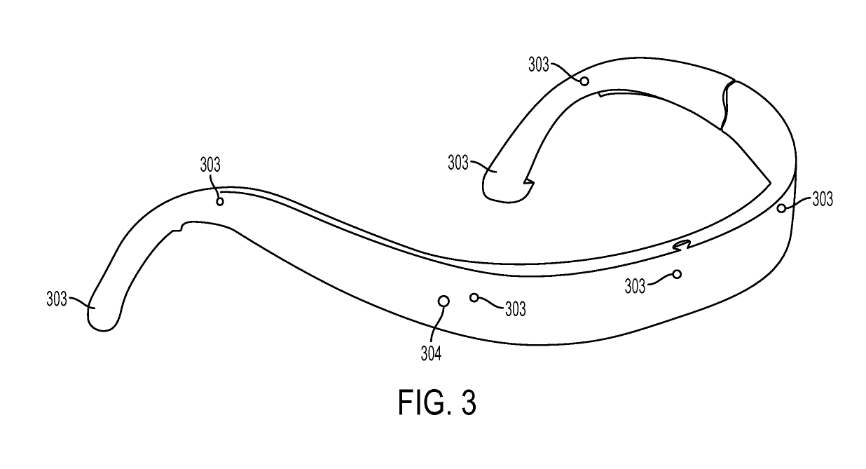

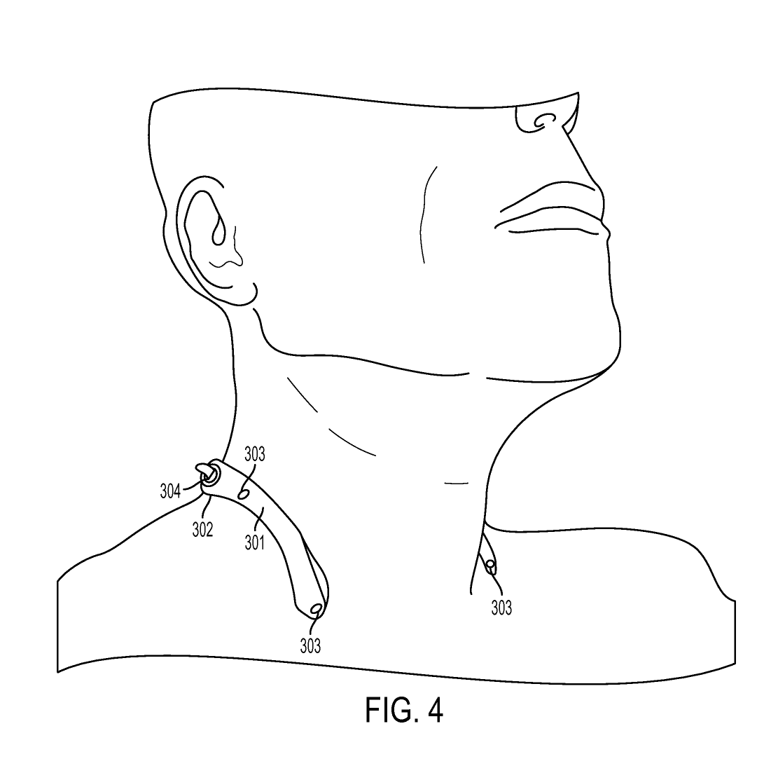

FIG. 3 and FIG. 4 show a collar-mounted microphone array 301.

FIG. 4 illustrates the collar-mounted microphone array 301 positioned on a user. A collar-band 302 adapted to be worn by a user is shown. The collar-band 302 is a mounting substrate for a plurality of microphones 303. The microphones 303 may be circumferentially-distributed on the collar-band 302, and may have a geometric configuration which may permit the array to have a 360-degree range with no obstructions caused by the collar-band 302 or the user. The collar-band 302 may also include an accelerometer 304 rigidly-mounted on or in the collar band 302.

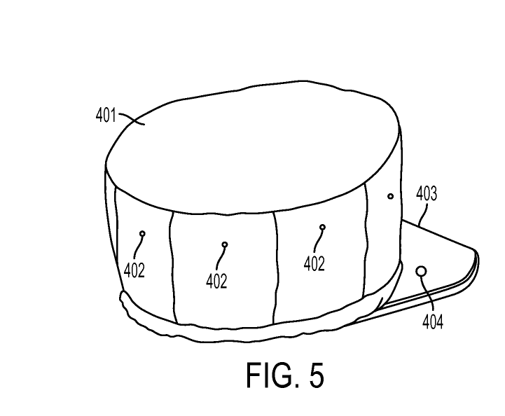

FIG. 5 illustrates a hat-mounted microphone array according an embodiment of the invention. FIG. 5 illustrates a hat 401. The hat 401 serves as the mounting substrate for a plurality of microphones 402. The microphones 402 may be circumferentially-distributed around the hat or on the top of the hat in a fashion that avoids the hat or any body parts from being a significant obstruction to the view of the array. The hat 401 may also carry on accelerometer 404. The accelerometer 404 may be mounted on a visor 503 of the hat 401.

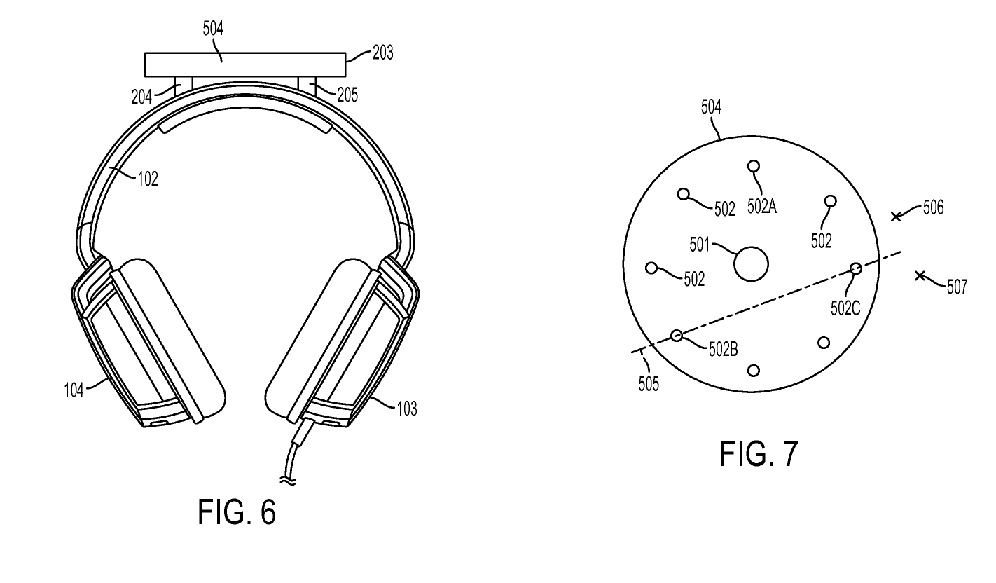

FIG. 6 shows a further embodiment of a microphone array according to an embodiment of the invention. A substrate is adapted to be mounted on a headband of a set of headphones. The substrate may include three or more microphones 502.

A substrate 203 may be adapted to be mounted on headphone headband 102. The substrate 203 may be connected to the headband 102 by mounting legs 204 and 205. The mounting legs 204 and 205 may be resilient in order to absorb vibration induced by the ear speakers and isolate microphones and an accelerometer in the array.

FIG. 7 shows a top view of a mounting substrate 203. Microphones 502 are mounted on the substrate 203. Advantageously an accelerometer 501 is also mounted on the substrate 203. The microphones alternatively may be mounted around the rim 504 of the substrate 203. According to an embodiment, there may be three microphones 502 mounted on the substrate 203 where a first microphones is not co-linear with a second and third microphone. Line 505 runs through microphone 502B and 502C. As illustrated in FIG. 7, the location of microphone 502A is not co-linear with the locations of microphones 502B and 502C as it does not fall on the line defined by the location of microphones 502B and 502C. Microphones 502A, 502B and 502C define a plane. A microphone array of two omni-directional microphones 502B and 502C cannot distinguish between locations 506 and 507. The addition of a third microphone 502A may be utilized to differentiate between points equidistant from line 505 that fall on a line perpendicular to line 505.

According an advantageous feature of the invention, an accelerometer may be provided in connection with a microphone array. Because the microphone array is configured to be carried by a person, and because people move, an accelerometer may be used to ascertain change in position and/or orientation of the microphone array. It is advantageous that the accelerometer be in a fixed position relative to the microphones 502 in the array, but need not be directly mounted on a microphone array substrate. An accelerometer 304 may be mounted on the collar-band 302 as illustrated in FIG. 4. An accelerometer may be mounted in a fixed position on the hat 401 illustrated in FIG. 5, for example, on a visor 403. The accelerometer may be mounted in any position. The position 404 of the accelerometer is not critical.

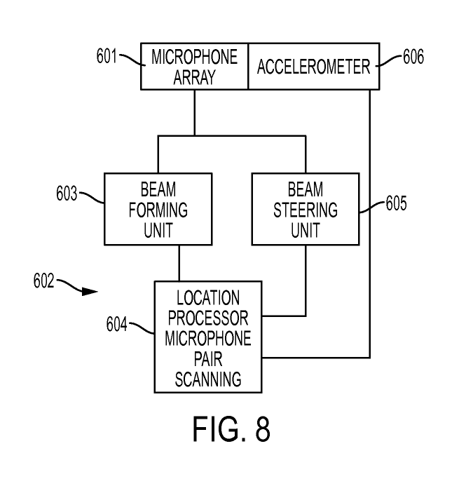

FIG. 8 shows a microphone array 601 in an audio source location and isolation system. A beam-forming unit 603 is responsive to a microphone array 601. The beamforming unit 603 may process the signals from two or more microphones in the microphone array 601 to determine the location of an audio source, preferably the location of the audio source relative to the microphone array. A location processor 604 may receive location information from the beam-forming system 603. The location information may be provided to a beam-steering unit 605 to process the signals obtained from two or more microphones in the microphone array 601 to isolate audio emanating from the identified location. A two-dimensional array is generally suitable for identifying an azimuth direction of the source. An accelerometer 606 may be mechanically coupled to the microphone array 601. The accelerometer 606 may provide information indicative of a change in location or orientation of the microphone array. This information may be provided to the location processor 604 and utilized to narrow a location search by eliminating change in the array position and orientation from any adjustment of beam-forming and beam-scanning direction due to change in location of the audio source. The use of an accelerometer to ascertain change in position and/or change in orientation of the microphone array 601 may reduce the computational resources required for beam forming and beam scanning.

The techniques, processes and apparatus described may be utilized to control operation of any device and conserve use of resources based on conditions detected or applicable to the device.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of audio signature generation and automatic content recognition have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A microphone array comprising:
a base configured to be worn by a user; and
three or more microphones mounted on said base; wherein said microphones are mounted in a configuration with a first microphone mounted in a position that is not co-linear with a second microphone and a third microphone.

2. A microphone array according to claim 1 wherein said microphones are mounted on said base in a configuration where, for every angle of azimuth referenced from said microphone array from 0 degrees to 360 degrees, there are at least two microphones in said array which include the angle of azimuth within their field of sensitivity and are unobstructed by said base and user.

3. A microphone array according to claim 2 wherein said base is a pair of headphones.

4. A microphone array according to claim 3 wherein said microphones are mounted on a headband of said headphones.

5. A microphone array according to claim 3 wherein said microphones are mounted on a substrate and said substrate is attached to said headphones.

6. A microphone array according to claim 5 wherein said substrate is attached to a headband of said headphones.

7. A microphone array according to claim 1 wherein said microphone array has 8 microphones.

8. A microphone array according to claim 7 wherein said microphones are mounted in a generally coplanar configuration.

9. A microphone array according to claim 2 wherein said substrate is a wearable collar.

10. A microphone array according to claim 2 wherein said microphones are mounted on a hat.

11. A microphone array according to claim 10 wherein said microphones are circumferentially distributed on a lateral portion of said hat.

12. A microphone array according to claim 1 wherein said microphones are omni-directional microphones.

13. A microphone array according to claim 1 wherein said microphones are optical microphones.

14. A microphone array according to claim 1 wherein said microphones are silicone-based microphones.

15. A microphone array according to claim 1 further comprising an accelerometer mechanically-linked to said microphone array.

16. An audio source location tracking and isolation system comprising:
a microphone array having three or more microphones;
an accelerometer mounted in a fixed relationship to said microphone array;
a location processor responsive to said accelerometer;
a beam-forming unit responsive to said microphone array and a location compensation signal generated by said location processor; and
a beam steering unit responsive to said microphone array and said location compensation signal generated by said location processor.

17. An audio source location tracking and isolation system according to claim 16 wherein said microphone array is mounted on a base configured to be worn on a user.
